(19) United States
(12) Patent Application Publication
(10) Pub. No.: US 2005/0086115 A1
(43) Pub. Date: Apr. 21, 2005

(54) Method and apparatus for efficient order placement and fulfillment in a retail establishment

(76) Inventor: Thomas C. Pearson, Lino Lakes, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/685,811

(22) Filed: Oct. 15, 2003

(51) Int. Cl. G06F 17/60

(52) U.S. Cl. 705/16

(57) ABSTRACT

Order placement and fulfillment are provided by assigning customers identification cards and allowing the customers to predefine preferences and pre-establish credit. Said preferences and credit are accessible by a kiosk that reads the identification card. Orders are placed at the kiosk based upon the predefined preferences and the cost of items ordered is automatically charged against the pre-established credit. Order information is delivered to a display such that store personnel can efficiently fill the order.

### BACKGROUND OF THE INVENTION

I. Field of the Invention

The present invention relates generally to an improved method and apparatus for order placement and fulfillment in retail establishments. The method and apparatus of the present invention can be used in virtually any retail setting, but is particularly efficacious in retail service establishments where repeat customers regularly make purchases of the same item or items. More specifically, electronic data processing equipment and customer cards upon which machine readable data is stored are employed to create greater efficiency in order placement and fulfillment.

II. Description of the Related Art

Since the advent of the electronic digital computer, point of purchase and order entry systems have grown increasingly powerful and complex. These systems are not only used to handle order placement and fulfillment, but are also used to process payment, handle accounting functions, provide inventory control, assist in product placement, and even track customer purchases to attempt to determine preferences.

Similarly, prior art systems provide automated methods for determining, capturing and presenting customer information. Examples showing the range of such systems disclosed in the prior art are discussed below.

U.S. Patent Application Publication No. 2002/0045959 to Van Overveld relates to a smart card which contains a clothing profile. This clothing profile is updated when a purchaser selects new items of clothing to purchase. The profile can be read out so that sales personnel can better assist the customer in purchasing clothing. The system disclosed in this patent application can also be used to assist the customer in deciding which clothes to mix and match on any particular day.

The U.S. Patent Application Publication No. 2002/0133545 to Fano et al describes a system for wireless communication with various providers of goods and services. The Fano system is designed to serve as a “mobile valet” that provides information based upon the location of a mobile unit. The locations can be anything from a store, warehouse, building complex, office complex, bank, stadium, golf course, or the like. The “mobile valet” generates a location-based menu and the user can use the device to order services based upon the services that are available at that particular geographic location.

U.S. Pat. No. 5,566,327 to Sehr relates to a debit card system that can be used by theme park patrons to purchase goods. The system develops an audit trail of products and services delivered to the patrons to enable management decisions to be made based upon utilization of such debit cards.

U.S. Pat. No. 5,665,951 to Newman et al discloses a system that allows one to determine whether items contemplated for purchase would be compatible with items already owned by the customer.

U.S. Pat. Nos. 6,243,447 and 5,923,735, both to Schwarz et al, disclose self-service checkout systems. In U.S. Pat. Nos. 6,313,745 and 6,129,274, Suzuki a disclosed system for tracking items which a customer may take into a fitting room as well as a system that includes a shopper profile on a smart card. The smart card can be used to record the customer information which includes not only the customer's name but also customer preferences, a shopping history, as well as a record of coupons and incentive points that the customer may have earned. The card is theoretically helpful in providing assistance to the customer and also enables the retailer to provide promotional information to the customer. However, Suzuki does not show a quick and easy order processing mechanism.

U.S. Pat. No. 6,098,876 to Terranova discloses a system for dispensing fuel at a gas station. The system takes into account customer preferences by displaying advertising or other information to the customer as the customer is pumping gasoline. Information that may be displayed includes personalized greetings and customer-selected information such as news, entertainment, advertising, and merchandising materials. The system disclosed in Terranova does not specifically contemplate the use of a debit card for handling the financial aspects of the transaction, nor do the preferences stored on a transponder that the customer carries relate specifically to the product being purchased, i.e. the type of gasoline the customer would want to purchase.

U.S. Pat. No. 6,434,530 to Sloane et al discloses an interactive system used in shopping venues. The system includes a wireless transceiver that can be carried by the user throughout a retail establishment. As the user reaches certain locations within the retail establishment, messages displayed on the portable transceiver are changed to provide information regarding the items offered in that portion of the store.

U.S. Pat. No. 6,513,015 to Ogasawara relates to a system to enhance customer recognition and to allow store personnel to deal with the customer in a more personalized fashion. The system contemplates that customers will carry a device which triggers a camera and a data processing terminal when a customer enters the store. The terminal displays a picture of the customer, the name of the customer, a customer profile, and the shopping history of the customer. Store personnel can use this information to assist the customer in selecting items for purchase.

From the foregoing, it should be clear that a number of systems have been developed to identify customers and assist in tracking their preferences. Such systems are generally used to assist store personnel in their efforts to sell additional products to the customer. These systems are generally not used, however, for automated order placement by a customer and prompt fulfillment of that order by store personnel.

In view of the foregoing, it would be preferable to provide a method and apparatus which would permit a customer to be able to quickly and efficiently place an order for predefined goods in a retail establishment and then have the order quickly fulfilled by store personnel. In such a system, the customer, preferably, will not have to waste time standing in line or waiting for payment transactions to be completed. There is also a real need for such a system that not only maintains a record of customer preferences, but also provide store personnel with the opportunity to deal with the customer on a more personnel and direct basis.

### SUMMARY OF THE INVENTION

In view of the foregoing, it is therefore an object of the present invention to provide an improved method and apparatus for order creation and fulfillment in retail establishments.

Another object of this invention is to provide a system that permits a customer to predefine a set of preferences and later use the system and the preferences provided to place orders for goods or services.

Another object of the present invention is to provide such a method and system which employs a device upon which information unique to the customer can be stored and which the customer can use in conjunction with an order entry apparatus to place an order.

Still another object of the invention is to provide a system which not only includes such an information storage device and order entry equipment, but also is interconnected with a point of purchase system in a store such that the order can be quickly processed and the items ordered can be quickly delivered to the customer.

Still another object of the invention is to provide a system as outlined above which handles not only the financial transaction promptly and efficiently, but also provides store personnel with information related not only to the customer's order, but also personal information related to the customer.

In accordance with the foregoing objectives, the method and apparatus of the present invention allows customers to register themselves. This registration process is used to create a customer account in a database and create an identification card to be used by the customer when making purchases. The identification card can be a debit card or any other card that provides in machine-readable form the customer's name or account information. The customer can also articulate and store a set of preferences for the customer in the database. Once the registration process is complete, the customer may, upon entering the retail establishment, insert the identification card in a kiosk. The kiosk then displays information based upon the customer's preferences and the customer uses the kiosk to place an order for goods and services. The order is then sent from the kiosk to the retailer's production system or a stand alone production display which is read by store personnel and processed so the goods and services ordered can be promptly delivered to the customer. When a debit card is used, the debit card is automatically debited as the order is filled to speed the delivery process. Similarly, when the card provides account information, the customer's account can be automatically debited. The information displayed to the store personnel not only can include the items ordered but also personal information such as the customer's name so that the store personnel can greet the customer in a personal manner when the items ordered are prepared and delivered.

The objects and advantages of this invention will, of course, become more clear from a reading to the following detailed description of the preferred embodiment in conjunction with the accompanying drawings.

### BRIEF DESCRIPTION OF THE DRAWINGS

FIG. 1 is a schematic diagram showing the system architecture of the present invention.

FIG. 2 is a schematic diagram of a kiosk which resides at a retail establishment using the present invention.

FIG. 3 is a diagram of a stand alone production management display unit that may be used as part of the present invention.

FIG. 4 is a flow chart providing an overview of the customer initialization process of a preferred embodiment of the present invention.

FIG. 5 is a flow chart providing an overview of how information relating to a customer can be changed.

FIG. 6 is a flow chart showing how gift cards used in conjunction with the present invention can be created.

FIG. 7 is a flow chart of how the present invention controls activation of a gift card.

FIG. 8 is a flow chart providing an overview of the order placement process of a preferred embodiment of the present invention.

FIG. 9 is a flow chart showing how orders may be sent to the production management display described in FIG. 3 as part of an order fulfillment process.

FIG. 10 is a flow chart showing how orders may be sent to an existing retail management system is part of an order fulfillment process.

FIG. 11 is a flow chart showing post transaction processes that may be performed using the present invention.

### DETAILED DESCRIPTION OF A PREFERRED EMBODIMENT

The present invention facilitates the use of pre-defined preferences to create an efficient retail transaction. It gives customers who repeatably purchase the same products and services the ability to “pre-define” their preferences. The invention also provides an environment that allows customers to transact efficiently with a retailer based upon those known preferences.

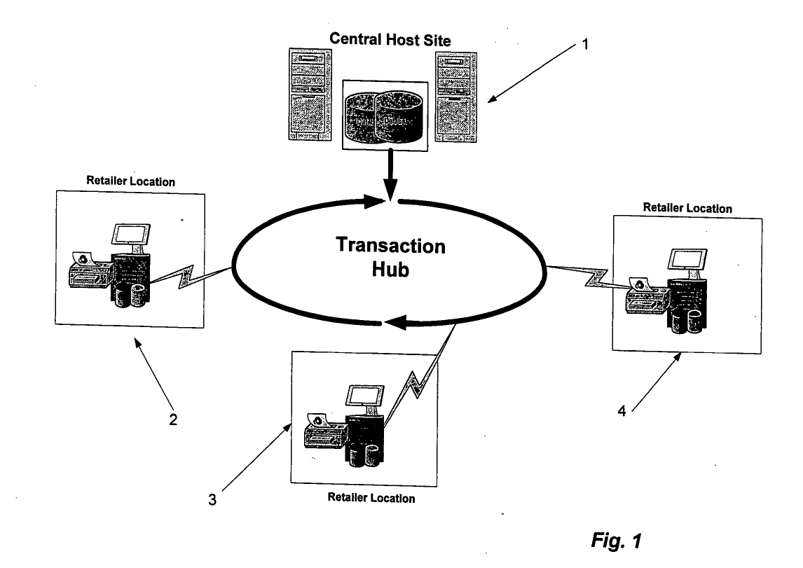

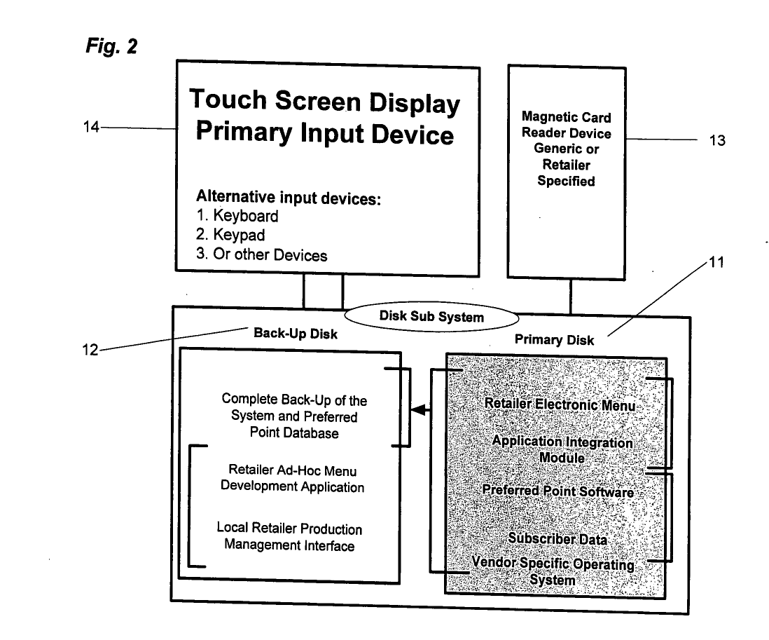

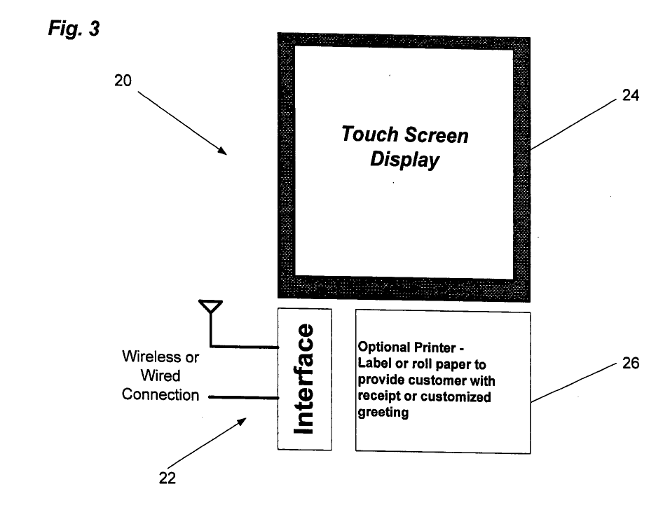

As shown in FIG. 1, the system of the present invention includes a central host site 1 which is networked to a plurality of retail locations, three of which (2-4) are shown in FIG. 1. Each retail location is equipped with several different components. These include a kiosk 10 shown generally in FIG. 2 and either a display 20 of the type shown in FIG. 3 or some other existing retail management system capable of being coupled to the kiosk 10. Each store location may also include a server upon which data is stored and through which information is conveyed between one or more kiosks 10 and either the production management display 20 or the existing retail management system. Either such a server or the kiosks 10 directly can be used to communicate with the central host site 1. Such communication takes place over a private network or via public network such as the World Wide Web. Thus, the central host site 1 and the kiosks 10 (independently or through a server) must all be connected to the network.

The central host site 1 is used to create, maintain and update a database which can either be downloaded to the retailer locations 2, 3 or 4, or can be accessed directly from those retailer locations. As described in further detail below, this database includes information related to the customers, their preferences, the balances on customer debit cards, and the like. The data in the database can be replicated on the server or a kiosk 10 at the retail locations. Data replications can be either event triggered, performed on a store-and-forward basis, or forwarded to the retail location based upon certain scheduled events.

Each retail location 2-4 contains a copy of data stored in the database of the central host site 1. This can be a copy of the complete database, a copy of data related to the registered customers who frequent the particular retail store, or some other subset of the data stored in the database. The data in the database stored at the retail locations age from the system based upon usage or lack of usage. Also, roaming files and special usage data can be retained locally. The system can, of course, create roaming profiles which can be disseminated to each retailer location 2, 3 and 4. The entire system is designed so that both the central host database and the database at the retail locations are updated regularly. This is done to ensure that the system maintains proper account balances. Based upon customer product selection and financial transactions at the retail locations, the databases are also updated continuously to ensure that the customer profiles and customer preferences are correct and accurate. Likewise, the databases must be updated to provide accurate reporting by the system. The need for continuous transaction processing in the present system will become more apparent below when the process employed using the present invention is more fully described.

A key aspect of the system of the present invention is the kiosk 10 employed at each retail location. As shown in FIG. 2, the kiosk 10 is essentially a computer. The computer may have both a primary disc 11 and a backup disc 12. Attached to the computer as part of the user interface is a magnetic card reader 13 and a touch-screen display 14. Alternatively, the system could include a standard display device in combination with a keyboard, keypad or other input device.

A number of items are stored on the disc subsystem of the kiosk 10. These include the computer's operating system, the software used to control the kiosk 10, and subscriber data all which is updated and exchanged regularly from the central host site 1. Also, retailer-specific software could be hosted on the disc subsystem of the kiosk 10. This software could include the menu of goods and services offered by the retailer as well as an application integration module. Also stored on the disc subsystem is a complete backup of the system and the database, as well as a retailer interface to support menu management and the production system of the retail establishment. This software permits the retailer to develop a menu application and also permits the kiosk 10 to communicate with the production management display or the retailer's pre-existing retail management system.

The kiosk 10, of course, is the primary mechanism used by customers in the retail establishment. Some other device must be used by the employees of the retail establishment to receive and process orders for goods and services. FIG. 3 shows a production management display 20 which includes either a wireless or wired connection 22 to the kiosk 10 and a display 24 that displays orders that have been placed by customers at the kiosk. An optional printer 26 can also be provided for purposes of printing a receipt. A touch screen display 24 is preferably used (but some other input device can be used as well) to tell the system when orders are being processed and when the goods or services ordered have been delivered to the customer. Alternatively, the kiosk 10 can be configured to communicate with a retailer's existing retail management system for purposes of order processing.

Operation of the present invention occurs in three primary phases. These phases can generally be referred to as the initialization phase, the order-fulfillment phase and the post-transaction phase. During the initialization phase, data is collected from the customer, stored in a database in the retailer's computer and a debit card is created for the customer. Actual purchases are made during the fulfillment phase. Various reports are prepared and transactional analysis is performed during the post-transaction phase. Typically, these will also be other phases as well. In one such phase, a customer can modify the data related to the customer that is stored in the database. In another such phase, the system can create a custom profile and edit data in the database to include profile information.

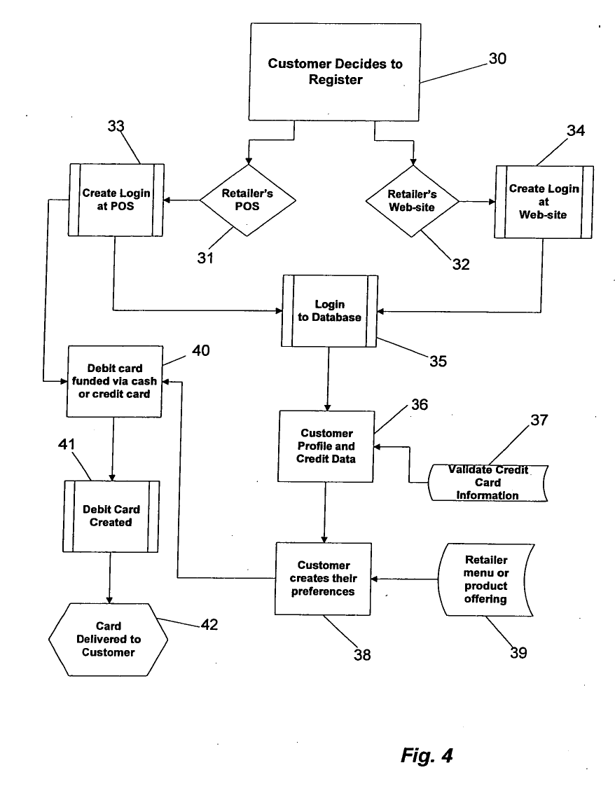

FIG. 4 is a flow chart showing the principle steps performed during the initialization phase. At step 30, the customer decides to register with the system. The customer can either do so at a point-of-sale terminal in the retailer's establishment (step 31) or from any computer via the Worldwide Web by accessing the retailer's website (step 32). In either case, a customer login profile is created in a database maintained on the host site 1. At step 33, a login profile is created using one of the retailer's point-of-sale terminals. At step 34, a login profile is created via the Internet using the retailer's website.

Whether created at a point-of-sale terminal 33 or some other computer 34, the login profile includes information such as the customer's name, address, phone number and e-mail address. As part of the step of creating the login profile, a unique user name and password can be selected and assigned to the customer. This allows the user to log into the database and add or modify data related to the customer.

At this point in the process, a customer creating a login profile at a point-of-sale terminal (step 33) is faced with two choices. The customer can either log in to the database at step 35 or the customer can proceed directly to step 40 and begin the steps associated with securing a debit card. Customers creating a login profile via the Internet (step 32) from another computer would typically proceed to step 35. In either case, customers proceeding to step 35 log in and supply additional information to be stored in the database. At step 36 additional customer profile information and credit data is supplied by the customer. For example, the customer can supply credit card information to be used to pay for purchases. At step 37 the system validates the credit card information.

Steps 38 and 39 are perhaps two of the most important steps in the process. At steps 38 and 39, the customer reviews the menu of products offered by the retailer and the customer uses the menu to identify and store in the database the customer's preferences.

Once the system has collected and stored the desired data in the database (steps 36-39), a customer initializing an account over the Internet can request a debit card (step 40). As mentioned above, customers initializing at the retailer's store can proceed to step 40 before entering the data collected in steps 36 and 38. These customers can log in later to supply such data.

At step 40, the debit card is funded either using cash or a credit card. When a credit card is used, the system can be programmed to automatically restore the debit card to some predetermined amount when the balance on the debit card falls below a specified level. The credit card is then charged the appropriate amount. In either case, the debit card is created at step 41 and delivered to the customer at step 42. If the customer is in the retail store, the debit card is delivered at step 42 by simply handing it to the customer. The debit card is mailed to those customers initializing via the Internet. The card, itself, is designed so that it can be read by the card reader 13 of the kiosk 10 in any retail location 2-4. The debit card serves as an identification card and, thus, and includes data that allows the system to identify the customer. The system can also check the database to determine the customer's preferences and the monetary balance. The credit information related to the credit card stored in the database could alternatively be used to automatically charge the customer's credit card account whenever a purchase is made by the customer.

While it is possible to complete the entire initialization process using one of the retailer's point-of-sale terminals, this can cause delays in the retail establishment. To avoid such problems, the system can be set up so that most of the initialization process is performed via the Internet and only registration of the identification card, user name, user password, and a valid dollar amount for the card are established at the point-of-sale terminal in the store.

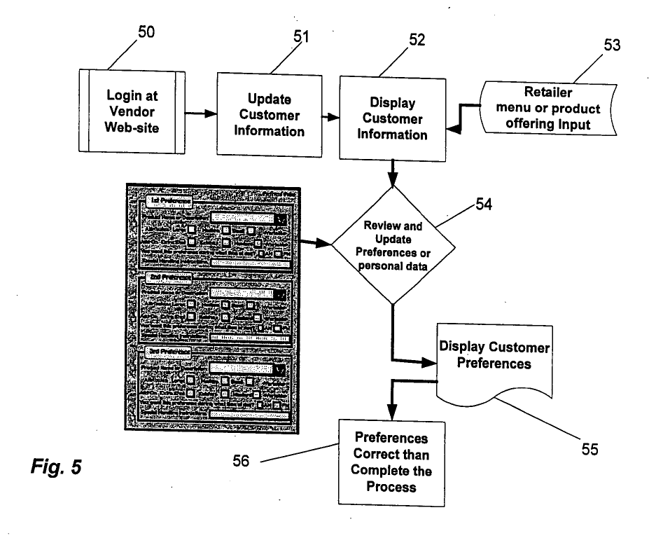

Over time, customer preferences and the menu of items sold by the retailer can change. FIG. 5 is a flow chart showing how the process is used to change the customer preferences stored in the database.

At step 50, the customer logs onto the website using the assigned user name and password and requests at step 51 to update the customer's information. The customer preference information is then displayed at step 52 along with the retailer's current menu of product offerings (step 53). The customer reviews and updates the preferences at step 54. The revised preferences are displayed at step 55 and the customer is asked at step 56 to verify the accuracy of the modified preferences to complete the process.

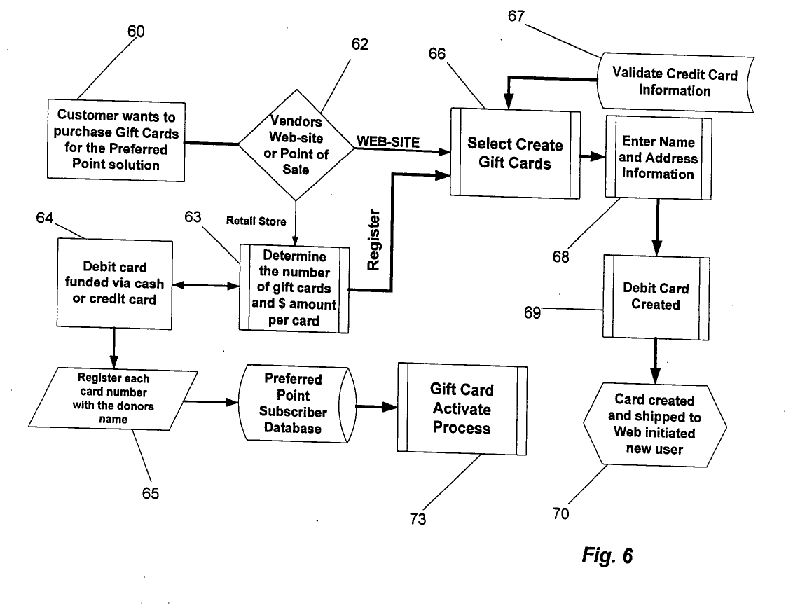

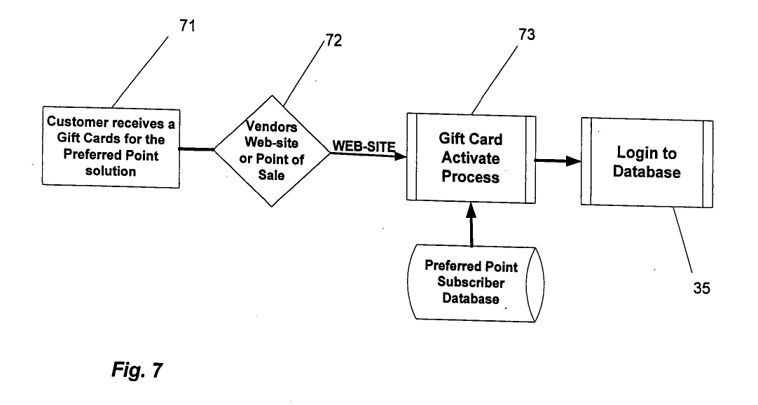

The system of the present invention can also be used in connection with gift cards purchased by one customer for use by another customer. The processes used to create and activate gift cards are shown in FIGS. 6 and 7.

At step 60 in FIG. 6, the customer makes a decision to acquire the gift card. The customer then decides to acquire the gift card at the retail store or via the retailer's website at step 62. If the gift cards are to be purchased at the store, the number of gift cards and the dollar amount for the gift cards desired are selected at step 63. The customer then pays for the gift cards at step 64 and the card number and name of the customer buying the gift card is recorded in the system database at step 65.

Gift cards can also be purchased via the retail store's website. After logging in, the customer selects the create gift cards option at step 66. As part of this step the customer inputs the number of cards and the denominations desired. The system then validates the customer's credit card information (step 67) to secure payment for the gift cards.

At step 68, the customer is asked to enter name and address information for the recipient of the gift card. This information is stored in the system database and the system then creates the cards at step 69. At step 70 the card is shipped to the recipient at the address provided by the customer.

FIG. 7 shows the gift card activation process. At step 71, the recipient receives the gift card. The customer then can activate the card either at the retailer's website or at the retailer's store (step 72). If the website is used, the recipient can activate the card at step 73 and then log into the retailer's database (step 35) and supply profile and preference information as discussed with reference to steps 36-39 in FIG. 4.

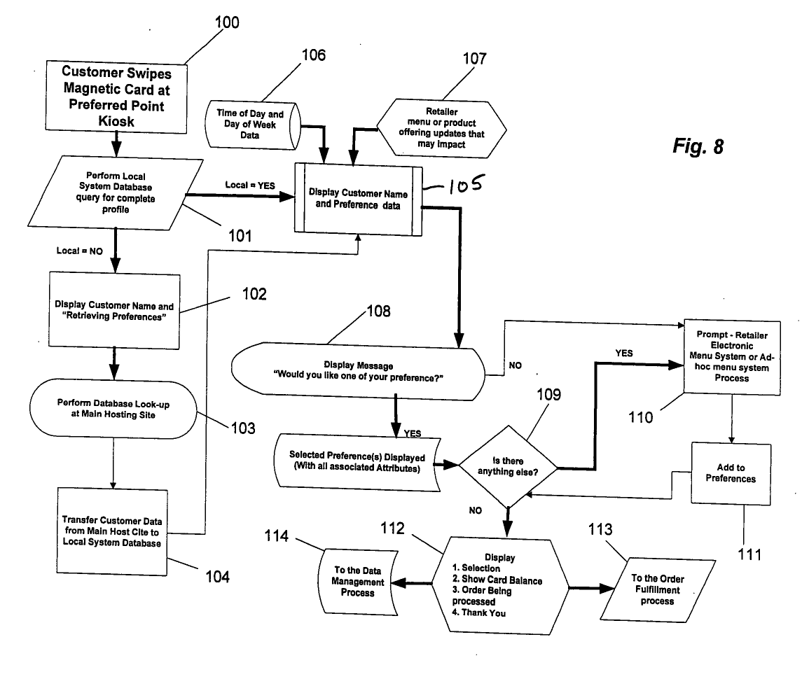

Customers possessing a debit card or an activated gift card can use these cards to efficiently place orders for goods and services and then have those orders fulfilled at the retail establishment. The process for placing an order is shown in FIG. 8.

First, the customer approaches the dedicated kiosk 10 and, at step 100, swipes the card through the card reader 13. The system then performs a local system database query at step 101 to see if the customer's data resides locally. If not, the kiosk display shows a message indicating the customer's name and the fact that the system is retrieving preferences (step 102). At the same time, the system also searches the database at the main hosting site (step 103) and copies the customer's preference data from the main hosting site to the local system database at step 104.

If the customer's preference data resides in the local system database (or once the data has been copied from the main hosting site to the local system database), the kiosk 10 displays the customer's name and preference data on file at step 105. The display can also indicate other information such as the time or day of the week (106) or provide information which relates to other products available, products on sale or the like (107). If desired, the customer can be prompted to provide a password that the system can use to validate the customer's account.

At step 108, the system asks the customer whether he or she would like to select one of the customer preferences on file in the database. The customer then answers this query. An affirmative response (i.e. selection of a preference) causes the system to tag the preference and to query if the customer would like anything else (step 109). Either a negative answer at step 108 or a positive answer at step 109 causes the menu of products offered to be displayed at 110. When the customer selects an item from the menu, the customer is asked whether the selected item should be added to the preferences at step 111. Steps 109-111 are repeated until the customer responds at step 109 that there is nothing else. At that point, the system proceeds to step 112. Information related to the item(s) ordered and the remaining debit card balance are displayed. A receipt can also be printed. The order information is also forwarded at step 113 to the fulfillment portion of the system and to the data management portion of the system at step 114.

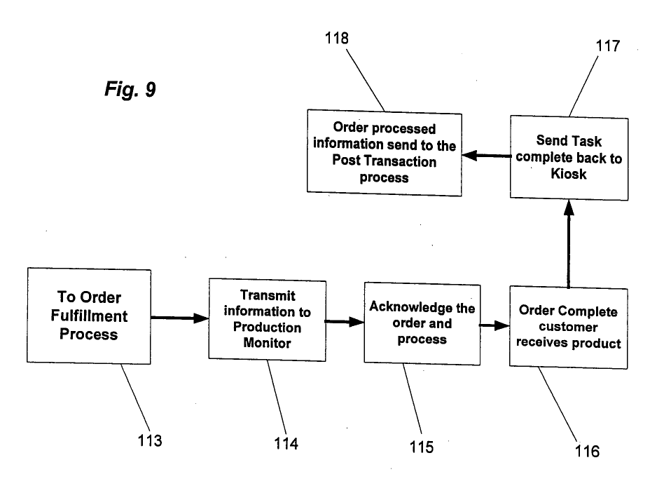

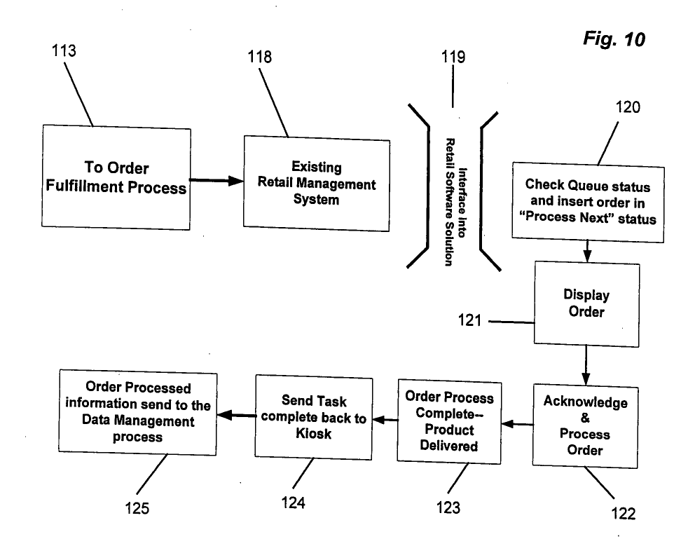

As indicated above, stores using the present invention may choose to integrate it with an existing point of purchase system or with the production monitor 20 described with reference to FIG. 3. FIG. 9 shows how orders are processed when integration is with the monitor 20. FIG. 10 shows how orders may be processed when such integration is with an existing point-of-purchase system.

As shown in FIG. 9, when orders are submitted for order fulfillment at step 113, the information related to the order is transmitted at step 114 to the production monitor 20. An employee of the retail store acknowledges and fills the order at step 115 and then delivers the products ordered to the customer at step 116. Once the products ordered have been delivered, notice of completion of the order is sent back to the kiosk 10 at step 117. The system is also flagged to note the order has been filled and post-transaction processing can begin at step 118.

FIG. 10 is provided to show how the system of FIG. 1, when integrated with another retail management system, can transfer orders placed at the kiosk 10 to said retail management system. The retail management system can be virtually any such system on the market today. All that is required is a network connection, such as a wireless connection or an Ethernet connection, so that the computer of the retail management system can communicate with the kiosk 10. A software interface is also provided so the retail management system can properly process signals received from the kiosk 10.

As shown in FIG. 10, orders are sent to the fulfillment process at step 113. They are received by the retail management system at step 118. The orders are then processed at step 119 based upon instructions provided by the interface software. The retail management system then checks the queue status and inserts the order into the proper place in the queue at step 120. The order is displayed at step 121, acknowledged and processed by an employee of the store at step 122 and delivered to the customer at step 123. Once the order has been filled, a signal is sent to the kiosk 10 at step 124. As in FIG. 9, the kiosk 10 then sends data related to the order and its fulfillment to a data management process and the post-transaction phase begins. This occurs at step 125.

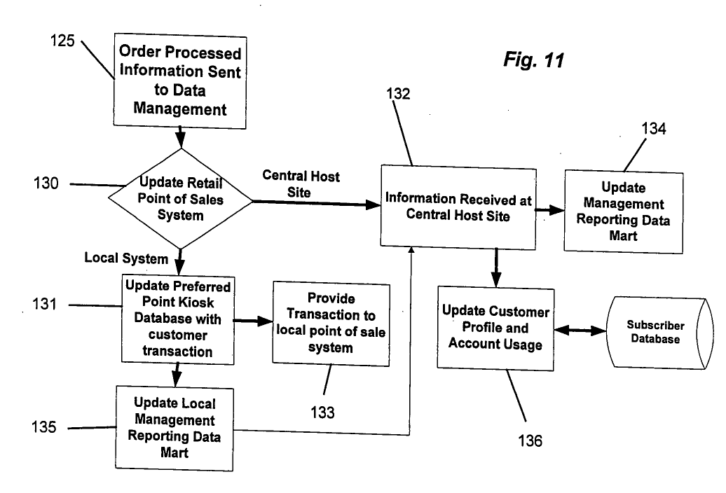

The specific steps performed in the post-transaction phase will vary greatly depending on the requirements of the retail store. FIG. 11 is provided as an example of typical steps that could occur.

FIG. 11 makes clear step 125 triggers post-transaction phase steps occurring both at the central host site 1 and at the kiosk 10. At step 130, the relevant data is provided both to the local system (e.g. 2) of the specific retail store and to the central host cite 1. At step 132, the information is received at the central host site for processing. The information is then processed to update any of a variety of management reporting tools at step 134 and the customer's profile and account usage stored in the database are updated at step 136.

At the retail location, the customer database in the kiosk is updated with information related to the transaction at step 131. Transaction data can be supplied to the customer's point-of-sale system at step 133 to accommodate accounting tasks. Also, local management reports for the particular store can be prepared at step 135. These reports, too, can be sent to the central host site 1 to assist, for example, in reporting activities of the store to the company headquarters.

As should be clear from the foregoing, the system of the present invention provides a high degree of integration that should substantially speed order fulfillment in retail establishments, particularly for repeat customers already registered with the system. Such a system has particular application to coffee shops and fast food restaurants. For example, a regular coffee shop patron can register for the system and as part of that process record a set of preferences and secure a debit card. Then when the patron enters the coffee shop, the patron merely goes to the kiosk 10, swipes the card through the kiosk's reader, and selects a preference and/or some other item from the menu. The order is processed and delivered by store personnel and the money for the goods ordered is automatically deducted from the debit card. The patron does not have to wait in line while others order products and then pay for their products using cash, check or credit card. Also, the system can be programmed to give priority to orders placed at the kiosk 10 by registered customers so that those customers receive their orders first. A customer's name and other personal information can be displayed along with the order so that the store personnel can personalize the retail experience for the customer.

The system of the present invention has many applications and can be configured in a number of ways. The foregoing description is provided to comply with the disclosure requirements of the patent laws, but is not intended to be limiting. The scope of the invention is, of course, defined exclusively by the following claims.

1. An apparatus for processing customer orders comprising:
a. an electronic database in which information unique to each of a plurality of customers is stored, said information including customer identification information for each of said plurality of customers, customer preference information for each of said customers, and information related to a customer's credit account for each of said customers;
b. a unique machine readable customer identification card assigned to each of said customers, said customer identification cards each containing at least some of the customer identification information stored in said database related to the customer to whom said identification card is assigned;
c. an order kiosk having a customer identification card reader, a display and an input device; and
d. an order processing display,
wherein when the card reader of said kiosk reads a customer identification card, the kiosk identifies the customer, retrieves and displays at least some of said preference information for the customer from the database, inquiries via said display whether the customer wants to place an order based upon the displayed preference information and, if the customer responds in the affirmative, causes said customer order to be displayed on the order processing display and debits the customer's credit account for the cost of the customer's order.

2. The apparatus of claim 1 wherein at least one of said customer identification cards is a debit card.

3. The apparatus of claim 1 wherein at least one of said customer identification cards is a gift card.

4. The apparatus of claim 1 further including means by which a customer can change the preference information stored in the database.

5. The apparatus of claim 1 wherein preference information for a customer stored in the database can be automatically changed based upon orders placed by the customer.

6. The apparatus of claim 1 wherein, if said customer responds in the negative, the display of the kiosk displays an alternative menu of purchase options and the customer can use the input device of the kiosk to place an order based upon the alternative menu displayed.

7. The apparatus of claim 1 wherein the customer can update said information related to the customer's credit account to establish additional credit.

8. The apparatus of claim 1 wherein said information related to a customer's credit account includes credit card information such that said apparatus can automatically place charges on a customer's credit card.

9. The apparatus of claim 8 wherein said charges are placed at the time the customer makes purchases.

10. The apparatus of claim 8 wherein said credit account is restored to a predetermined amount whenever the customer's credit account falls below a predetermined threshold by charging said credit card.

11. The apparatus of claim 1 wherein said order process display is part of a retail management system.

12. The apparatus of claim 1 having a second database, one of said databases residing at a central host site remote from said kiosk and the other residing at the retail location where the kiosk is located, and wherein data related to customer preferences and purchases can be exchanged between said first and second database such that both databases are kept current.

13. The apparatus of claim 12 wherein a customer can access at least one of said databases from a computer via a network and edit at least some of the information stored in said at least one database pertaining to said customer.

14. The apparatus of claim 1 wherein said network is the worldwide web.

15. A method for processing orders comprising:
a. creating a customer database in which, for each of a plurality of customers, identification, preference and credit account information is stored;
b. creating and assigning to at least some of said customers unique customer identification cards;
c. providing an order entry kiosk and an order processing display, said kiosk capable of (i) reading said customer identification cards; (ii) upon reading of one of said customer identification cards retrieving from said database at least some of the preference information related to the customer to whom said read identification card has been assigned; (iii) querying the customer regarding whether the customer wishes to place an order based upon said preference information; (iv) processing responses received from the customer; (v) sending information related to orders placed by customers to said order processing display; and (vi) updating the credit account information stored in said database based upon the price of orders placed by the customers; and
d. using said order entry kiosk and said order processing display to place and fill orders for products.

16. The method of claim 15 further including the step of updating said data in said database based upon items ordered by the customer.

17. The method of claim 15 wherein at least one of said customer identification cards is a debit card.

18. The method of claim 15 wherein at least one of said customer identification cards is a gift card.

19. The method of claim 15 further comprising the steps of (a) creating a second database, one of said databases located at a central host site and the other of said databases located at the same retail location as said kiosk; and (b) exchanging information between the two databases relevant to the customers having customer identification cards read by said kiosk.

20. The method of claim 15 further comprising the steps of (a) checking the credit account information of a customer to determine whether the customer's credit has fallen below a predetermined level; and (b) if the customer's credit has fallen below said predetermined level, using credit card information stored in the database to automatically charge the customer's credit card and, thus, restore the customer's credit to a predetermined amount.

21. The method of claim 15 further including the steps of (a) storing data related to items purchased by a customer; and (b) updating said customer's preference information based upon said items purchased by the customer.
